(19) United States
(12) Patent Application Publication
(10) Pub. No.: US 2007/0246954 A1
(43) Pub. Date: Oct. 25, 2007

(54) Door stop device

(76) Inventor: Leslie A. Ollinger, Grinnell, IA (US)

Correspondence Address: KLIMA LAW OFFICES, P.L.L.C., P. O. BOX 2855, STAFFORD, VA, 22555-2855, US

(21) Appl. No.: 11/406,376

(22) Filed: Apr. 19, 2006

(51) Int. Cl. E05C 17/44

(52) U.S. Cl. 292/338

(57) ABSTRACT

The present invention is directed to an improved door stop device, in particular an improved portable door stop device to handle different size doors and different size gaps between the door and floor. Further, the door stop device according to the present invention is configured to minimize or eliminate a user bending over to install or remove the door stop device.

### FIELD OF THE INVENTION

The present invention is directed to a door stop device, preferably a portable door stop configured to accommodate different doors.

### BACKGROUND OF THE INVENTION

There exist a number of different types of door stops configured to maintain a door in an open position. For example, there exists a stand alone rubber wedge-shaped door stop that can be wedged between the floor and the lower edge of the door to maintain the door open. Further, there exists a door stop that is permanently mounted to the bottom of the door (i.e. not portable) and stays with the door throughout the life of the door.

There exists a need for an improved door stop device, in particular a portable door stop device to facilitate cleaning and maintenance of commercial or institutional buildings. In a preferred embodiment, the door stop device can be easily and conveniently installed prior to cleaning, and then later removed after cleaning. Further, it is desirable that such a door stop can be installed and removed in a manner to minimize or eliminate the user bending over during installation or removal.

### SUMMARY OF THE INVENTION

The first object of the present invention is to provide an improved door stop device.

A second object of the present invention is to provide an improved portable door stop device.

A third object of the present invention is to provide a door stop having a substantially long handle to minimize or eliminate the user bending over to install or remove the door stop device.

A fourth object of the present invention is to provide a door stop device including a handle having a lower door gripping finger, and a pivotable arm portion configured to secure the door stop device from movement with the floor.

A fifth object of the present invention is to provide a door stop device including a handle having a lower door gripping finger combined with a pivotable leg portion, the leg portion being adjustable in length.

A sixth object of the present invention is to provide a door stop device including a bent handle portion having a lower door gripping finger, and a pivoting leg portion, the pivoting leg portion being a telescoping leg portion.

The present invention is directed to an improved door stop, preferably an improved portable door stop device.

A preferred embodiment of the door stop according to the present invention includes a combined handle and pivoting leg. The handle preferably an elongated (i.e. long) handle having an upper gripping or handle portion and a lower handle portion having door edge gripping portion (e.g. door gripping finger). In a preferred embodiment, the handle portion is bent so that the lower portion can be positioned flat against the side of the door, and the upper portion of the handle portion bends away from the door to facilitate gripping by a user. The lower door gripping portion of the handle, for example, can be a door gripping finger or extension provided at the lower end of the handle portion. For example, the handle portion is made of a flat metal strip, and a short portion (i.e. one-half inch to two inch) finger portion is made by bending the metal strip near the bottom thereof. The finger portion can be provided with a resilient plastic or rubber cover to enhance the frictional engagement with the lower edge of the door.

The door stop device includes a pivoting leg connected to the handle. The pivoting leg is preferably adjustable in length so that the door stop device can accommodate different doors throughout a building having different size doors or different size gaps between the floor and a lower edge of the various door. A lower end of the pivoting leg is preferably provided with a rubber stop or cover to enhance the frictional grip with the floor to facilitate locking the door stop device in place against the face of a door. For example, the pivoting leg can include an upper U-shaped bracket connected to the back of the plate handle (e.g. by welding) and a pin passing through an upper end of the pivoting leg and the bracket to provide a pivoting connection therebetween. The leg portion can be made as to be telescoping to make it adjustable in length. For example, the leg portion can be made of a lower tubular section slidably disposed within an upper tubular section. The upper tubular section can be provided with a series of vertical through holes and the lower tubular section can be provided with a spring biased pin configured so as to lock in one of the through holes in the upper tubular section. In this manner, the length of the pivoting arm can be adjusted and then lock in place.

The door stop device according to the present invention can be made of metal, plastic, fiberglass, graphite, carbon, wood, wood filled, glass filled, composite, or other suitable material. In one preferred embodiment, the handle portion is made of a flat strip of aluminum plate. A lower end of the aluminum plate is bent at approximately ninety degrees (90°) to form the door gripping finger or portion, and the metal plate is bent approximately ten degrees to forty-five degrees (10° to 45°) at or near the center thereof so that the upper handle of the metal strip extends away from the door when the door stop is installed up against the face of the door to facilitate a user gripping the upper handle portion of the handle. The upper portion of the handle can be provided with at least one through hole for hanging the door stop from a wall or custodian cart. Further, to lighten the handle, the upper portion of the aluminum plate can be drilled with a plurality of through holes to reduce material and weight while still being sufficiently strong to serve as a handle. In this same embodiment, the pivoting leg can be made of an aluminum bracket, an upper aluminum tubing section, and a lower aluminum tubing section slidably disposed within the upper aluminum tubing section. A rubber foot can be provided at the bottom of the lower aluminum tubing section. The movable locking pin is preferably made of steel to increase the strength of the pivot connection.

Another preferred embodiment of the door stop device according to the present invention can be made of plastic material, in particular plastic resin. This embodiment can be made by injection molding a portion or the entire door stop device. For example, the handle can be plastic injection molded as one piece, and the pivoting leg can be molded as two (2) separate piece assembled together as a telescoping leg. The assembled pivoting leg can then be assembled to the handle.

### BRIEF DESCRIPTION OF THE DRAWINGS

FIG. 1 is a perspective view of a preferred embodiment of the door stop device according to the present invention.

FIG. 2 is a side elevational view of the door stop device shown in FIG. 1.

FIG. 3 is a front elevational view of the door stop device shown in FIG. 1.

FIG. 4 is a rear elevational view of the door stop device shown in FIG. 1.

FIG. 5 is a partial broken away longitudinal cross-sectional view of a portion of the pivoting leg of the door stop device shown in FIG. 1.

FIG. 6 is a side elevational view of the door stop device, shown in FIG. 1, in operation against a door.

FIG. 7 is a broken away longitudinal cross-sectional view of the door gripping finger provided with a resilient cover.

### DETAILED DESCRIPTION OF PREFERRED EMBODIMENTS

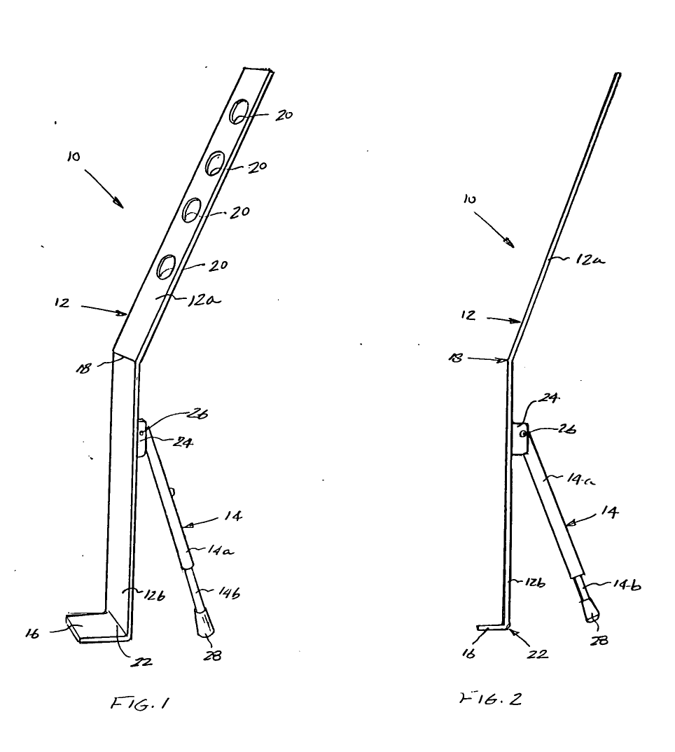

A preferred embodiment of a door stop device 10 according to the present invention is shown in FIGS. 1-7.

The door stop device 10 includes a combined handle 12 and pivoting leg 14. Specifically, the handle 12 is provided with an upper handle portion 12a and a lower handle portion 12b. The pivoting leg 14 is configured to be a telescoping leg, and includes an upper leg section 14a and a lower leg section 14b. The lower leg section 14b is slidably disposed within the upper leg section 14a.

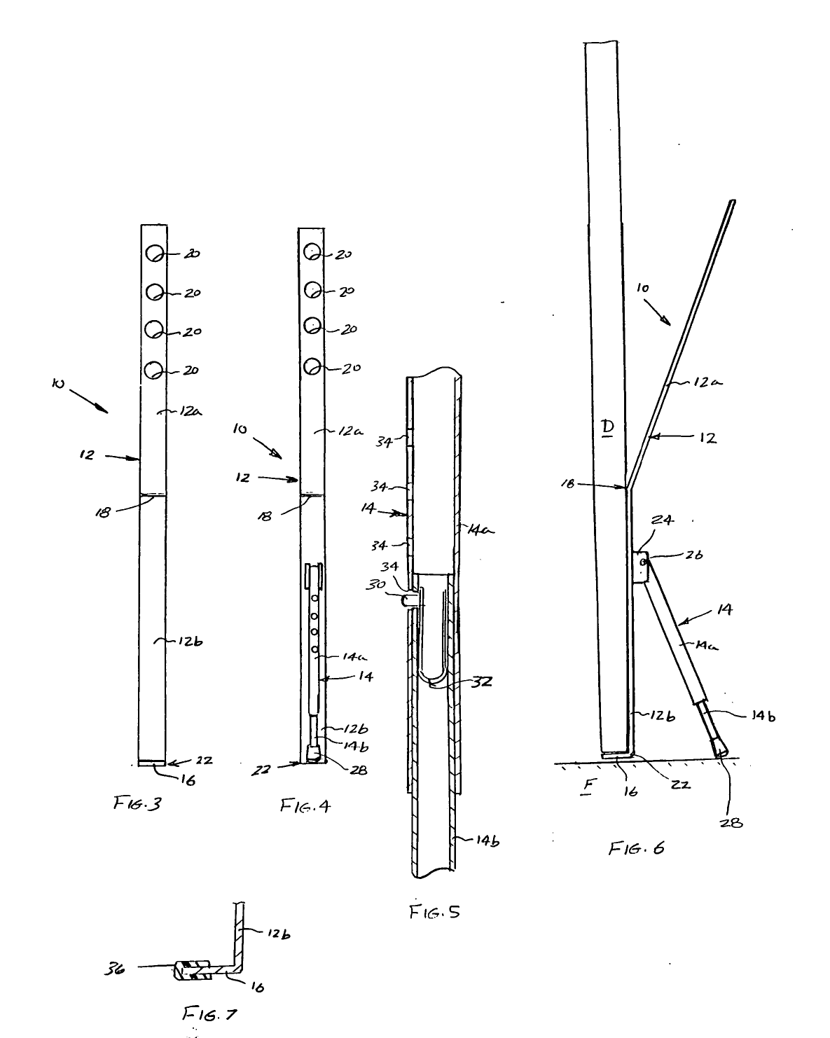

The handle 12 is provided with a door gripping finger 16 located at the bottom of the lower handle portion 12b. Further, the handle 12 is bent at axis or point 18 so that the upper handle portion 12a bends away from the door when mounted up against the door (see FIG. 6). The upper handle portion 12a is provided with at least one through hole 18 to hang the door stop device 10 from a wall, door or custodian cart. Further, he upper handle portion 12a is provided with additional through holes 18 to reduce the amount of material and the weight of the handle 12. The handle 12 can be made of metal, plastic, fiberglass, carbon fiber, composite or other suitable material. For example, the handle 12 is made from a flat plate of aluminum cut to shape and bent at axis or point 18 so that the upper handle portion 12a bends away from the vertical lower handle portion 12b. The aluminum plate is also bent at axis or point 20 (e.g. 90 degrees) to form the door gripping finger 16. Alternatively, the handle 12 is injection molded from plastic resin, in particular glass filled plastic resin to enhance strength, durability, and performance of the handle 12.

The pivoting leg 14 is connected to the handle 12 by a bracket 24 and pin 26 (FIG. 2). For example, the bracket 24 can be a U-shaped aluminum bracket bent from a strip from aluminum plate, and welded to the back of the handle 12. The bracket is drilled, and a pin 26 (e.g. steel pin) is inserted through both sides of the bracket 24 and secured in place (e.g. by forming head portions). The pin 26 serves as a pivot point for the pivoting arm 14 and in a preferred embodiment, the pivoting arm 14 freely pivots relative to the handle 12. In a preferred embodiment, the pivoting let 14 is a telescoping leg to adjust the length thereof to accommodate different doors or different clearances between the floor and the lower edge of different doors. The pivoting leg 14 is provided with a rubber foot 28 to resiliently grip the floor and prevent slippage there between.

For example, the pivoting leg 14 is made out of sections of aluminum tubing with the upper leg portion 14a having a larger diameter than the lower leg section 14b (FIG. 5). Specifically, the inner diameter of the upper leg section 14a is slightly greater than the outer diameter of the lower leg section 14b so that the lower leg section 14b can be slidably disposed within the upper leg section 14a and telescope there from. To provide a length adjustment, for example, a movable pin 30 mounted on a U-shaped spring 32 (FIG. 5) is disposed within the lower leg section 14b. The head of the pin 30 fits into one of four through holes 34 in the upper leg portion 14a to allow the length of the pivoting leg 14 to be adjusted to four (4) different lengths. The spacing and number of through holes can be adjusted or varied for different designs or size door stop devices. Further, alternative locking device can be used for securing the lower leg portion 14b within the upper leg portion 14a. The length of the pivoting let 14 can be adjusted by pushing inwardly on the head of the pin 30 until the upper leg portion 14a can slide relative to the lower leg portion 14b, and then allowing the head of the pin 30 to come through a different through hole 34 selected.

Alternatively, the bracket 24 is injection molded with plastic resin as part of the handle 12, and the pivoting leg sections 14a, 14b are injection with plastic resin as separate pieces, and then assembled together. The assembled pivoting leg is then assembled to the handle 12.

As shown in FIG. 7, the door gripping finger can optionally be provided with a resilient cover 36 (e.g. made of plastic or rubber) to enhance the frictional engagement with the bottom edge of the door.

During use the user installs the door stop device 10 against the door D to be maintained open, as shown in FIG. 6. Specifically, the door gripping finger 16 is slid under the lower edge of the door D in the gap between the door and the floor F. The user pushes the handle 12 against the side of the door until the lower handle portion 12b is flat against the side thereof, as shown in FIG. 6. The user then pushes the pivoting arm 14 (with users foot or toes) against the pivoting leg 14 until the rubber foot 28 firmly engages with the floor F causing the door gripping finger 16 to lift upwardly and firmly and engage with the lower edge of the door D. In this manner, the door D is firmly secured in place from movement. To remove the door stop device 10, the user uses his or her foot or toes to push outwardly the pivoting leg 14 to release the grip by the door stop device 10 on the lower edge of the door D. The user then simply pulls the handle 12 away from the door D and lifts the door stop device upwardly.

The length of the handle 12, in particular the upper hand portion 12a, is sufficiently long so that the user does not have to bend, or mininumally bends, to install or remove the door stop device from the door D. In this manner, the door stop device can be easily and quickly installed or removed with minimal effort and time by the user greatly increasing the convenience of the door stop device 10.

I claim:

1. A door stop device, comprising:
a handle including an upper handle portion and a lower handle portion, said upper handle portion being bent away from said lower handle portion and a door when the door stop is installed on the door, said handle including a door gripping finger; and
a pivoting leg connected to said handle, said pivoting leg configured to be adjustable in length, said pivoting leg including a resilient end portion configured to enhance frictional engagement with a floor beneath the door being stopped by said door stop device.

2. A door stop device, comprising:
a flat handle including an upper handle portion and a lower handle portion, said upper handle portion being bent away from said lower handle portion and a door when the door stop is installed on the door, said flat plate handle bend at a lower portion thereof to provide a door gripping finger; and
a pivoting leg connected to said handle, said pivoting leg configured to be adjustable in length, said pivoting leg including a lower leg section telescoping downwardly from said upper leg section, said pivoting leg including a resilient lower end configured to enhance frictional engagement with a floor beneath the door being stopped by said door stop device.

3. A door stop device, comprising:
a flat handle including an upper handle portion and a lower handle portion, said upper handle portion being bent away from said lower handle portion and a door when the door stop is installed on the door, said flat plate handle being bent at a lower portion thereof to provide a door gripping finger; and
a pivoting leg connected to said handle, said pivoting leg configured to be adjustable in length, said pivoting leg including a lower leg section telescoping downwardly from said upper leg section and a locking device for locking the length of said pivoting leg, said pivoting leg including a resilient lower end configured to enhance frictional engagement with a floor beneath the door being stopped by said door stop device.

4. A device according to claim 1, wherein said handle is a flat handle.

5. A device according to claim 4, wherein said flat handle is a flat metal plate.

6. A device according to claim 1, wherein said handle is bent in the middle thereof.

7. A device according to claim 4, wherein a lower end of said flat handle is bent to provide said door gripping finger.

8. A device according to claim 1, wherein said pivoting leg is a telescoping leg.

9. A device according to claim 8, wherein said pivoting leg includes an upper tubular section and a lower tubular section, said lower tubular section being slidably disposed within said upper tubular section to provide said telescoping leg.

10. A device according to claim 9, wherein said pivoting leg includes a locking device to lock said lower tubular section from movement within said upper tubular section to fix the length of said pivoting leg.

11. A device according to claim 10, wherein one said tubular section is provided with a series of different height through holes, and the other tubular section is provide with a spring biased locking pin configured to selectively engage one of said different height through holes to adjust the length of said pivoting leg.

12. A device according to claim 1, wherein a lower end of said pivoting leg is provided with a resilient foot covering said lower end to frictional engage the floor.

13. A device according to claim 1, wherein said pivoting leg includes a bracket connected to said handle, and a pin for securing the pivoting leg to said bracket.

14. A device according to claim 1, wherein said door gripping finger is provided with a resilient cover to enhance frictional engagement with a lower edge of a door being stopped by said door stop device.

15. A device according to claim 1, wherein said handle and said pivoting arm are made of metal.

16. A device according to claim 15, wherein said handle is made of plate aluminum metal and said pivoting arm is made of tubular aluminum metal.

17. A device according to claim 1, wherein said handle and said pivoting arm are made of plastic.

18. A device according to claim 17, wherein said handle and said pivoting arm are injection molded from plastic resin.

19. A device according to claim 18, wherein said handle and said pivoting arm are injection molded from plastic resin.
